(19) United States
(12) Patent Application Publication
(10) Pub. No.: US 2023/0266079 A1
(43) Pub. Date: Aug. 24, 2023

(54) HEAT EXCHANGE SYSTEM FOR FREEZING, TRANSFERRING, STORING, AND UTILIZING PHASE CHANGE MATERIAL AND APPLICATION OF THAT SYSTEM TO A THERMAL ENERGY STORAGE SYSTEM

(71) Applicant: Active Energy Systems, Knoxville, TN (US)

(72) Inventors: Mitchell Ishmael, Oak Ridge, TN (US); Lucas Mihlbachler, Knoxville, TN (US); Levon Atoyan, Knoxville, TN (US)

(73) Assignee: Active Energy Systems, Knoxville, TN (US)

(21) Appl. No.: 18/040,096

(22) PCT Filed: Aug. 4, 2021
(86) PCT No.: PCT/US2021/044574

§ 371 Date: Jan. 31, 2023

Related U.S. Application Data
(60) Provisional application No. 63/061,540, filed on Aug. 5, 2020.

(51) Int. Cl. F28F 19/00; F28D 20/00; C09D 5/00; C09K 5/06

(52) U.S. Cl. CPC F28F 19/006; F28D 20/00; C09D 5/00; C09K 5/066; F28D 2020/0082; F28F 2245/00

(57) ABSTRACT

A heat exchange system including an icephobic heat exchanger (IHEX) tank, a phase change material (PCM) held in the IHEX tank, an immiscible liquid layer held in the IHEX tank, a heat exchanger located within the immiscible liquid layer, and a distributor located above the heat exchanger configured to introduce a plurality of liquid PCM droplets into the immiscible liquid layer. The system further includes a transfer mechanism configured to remove PCM from the IHEX tank, and an external storage tank configured to receive the removed PCM. The immiscible liquid layer has a density lower than a density of both the solid and liquid PCM, and the PCM and the immiscible liquid layer meeting at a PCM-immiscible liquid interface.

### FIELD OF THE DISCLOSURE

One or more embodiments disclosed herein relate to systems and methods for efficiently exchanging heat between a phase change material and a cooling fluid, and systems and methods for an energy storage system.

### BACKGROUND

The daily demand of an electric grid is not steady but instead has certain hours of peak demand The requirement to handle peak demand leads to the design of oversized electrical grids and elevated costs. A universal low cost large scale solution is not available, so various energy storage technologies exist to lower the peak demand where possible. Thermal energy storage systems are commercially available but suffer due to various technical challenges. Ice energy storage in particular is attractive due to the high energy storage density and low-cost, non-toxic, non-flammable, abundant phase change material (PCM), but current designs suffer from low normalized heat transfer rates that require large expensive heat exchangers. Companies such as CALMAC and Evapco have commercialized ice-based thermal storage technologies. Many systems operate using an ice on coil technology, where heat transfer fluid is passed through a large bank of tubes submerged in stagnant water. While simple, this design is ineffective due to the formation of insulating ice layers upon the coils. This thermally resistant surface necessitates large heat exchanger surface areas, increasing capital costs in expensive tubing.

Static freezing is not the only technique used to make ice in industry, there are many other methods. One is freezing ice on a cooled surface by continuously running water over the outside surface. Once a satisfactory quantity of material is frozen, the surface is heated, and the ice is removed from the surface. By reheating the material to remove it, energy is wasted unnecessarily, and efficiency suffers. Another methodology involves freezing ice on the inside of a tubular surface, which is then continually scraped from the surface using a mechanical scraper. The energy required for scraping is significant, and the mechanical removal of ice causes wear-and-tear on the system. A third methodology has water placed in an open, rigid vessel and cooled from the top. Due to compressive forces generated as the water freezes from the top downward, the ice dislodges itself from the surface. The container is then inverted, the ice falls out, and the process starts over. Challenges include heat transfer limitations, and inconsistent self-release. In yet another design, ice is partially frozen in the presence of a freezing inhibitor like chloride salts or ethylene glycol. This creates an ice slush which is easily portable with high energy transfer. However, commercial issues arise from having a more expensive PCM with a lower energy density due to partial freezing and dopants.

Accordingly, there exists a need for a low cost, high heat transfer solution to the energy storage problem.

### SUMMARY OF THE DISCLOSURE

According to one or more embodiments disclosed is a heat exchange system including an icephobic heat exchanger (IHEX) tank, a phase change material (PCM) held in the IHEX tank, an immiscible liquid layer held in the IHEX tank, a heat exchanger located within the immiscible liquid layer, and a distributor located above the heat exchanger configured to introduce a plurality of liquid PCM droplets into the immiscible liquid layer. The system further includes a transfer mechanism configured to remove PCM from the IHEX tank, and an external storage tank configured to receive the removed PCM. The immiscible liquid layer has a density lower than a density of both the solid and liquid PCM, and the PCM and the immiscible liquid layer meeting at a PCM-immiscible liquid interface.

According to one or more embodiments disclosed is a heat exchange method for exchanging heat between a heat transfer fluid and a phase change material (PCM). The method includes holding an immiscible liquid layer in a tank, feeding a plurality of liquid PCM droplets into the tank proximate a top of the tank, contacting the plurality of liquid PCM droplets on a heat exchanger and cooling the liquid PCM droplets, producing a supercooled liquid, partially frozen liquid, or a solid PCM, and transferring the solid PCM from the tank.

Other aspects and advantages will be apparent from the following description and the appended claims.

### BRIEF DESCRIPTION OF DRAWINGS

FIG. 1 is an illustration of a thermal energy storage system according to embodiments disclosed herein.

FIG. 2A is an illustration of the front of an icephobic heat exchanger (IHEX) plate according to embodiments disclosed herein.

FIG. 2B is an illustration of the rear of an IHEX plate according to embodiments disclosed herein.

FIG. 3 is an illustration of the heat exchange method for freezing PCM according to embodiments disclosed herein.

FIG. 4 is an illustration of a method for transferring water and ice according to embodiments disclosed herein.

FIG. 5 is an illustration of an external discharge method according to embodiments disclosed herein.

### DETAILED DESCRIPTION

According to one or more embodiments disclosed herein is a heat exchange system and method that is low cost while achieving high heat transfer efficiencies and energy densities. Instead of freezing stagnant PCM upon the heat exchanger such as is common in the industry, liquid PCM in an immiscible lubricant flows across the heat exchanger surface and is frozen as it contacts the heat exchange surface. As the PCM freezes, gravity and bulk fluid forces remove it from the surface of the heat exchanger. This is possible due to surface modifications which make the heat exchanger “icephobic”, significantly lowering solid PCM adhesion to the heat exchanger surface. An icephobic heat exchanger (IHEX) mitigates the accumulation of solid on the heat exchanger surface as a material undergoes a phase change, and allows for the heat exchanger surface areas up to ten times smaller than conventional ice-on-coil based heat exchangers without reducing efficiency.

The smooth polymer surface may be one or more fluorinated materials like polytetrafluoroethylene (PTFE), commonly known as Teflon. Other possible modifications to increase icephobicity include silicone-based coatings and epoxies or microstructural surface modification known as SLIPS (Slippery Liquid Infused Porous Substrates).

Frozen PCM made by the IHEX can be stored and the thermal energy can be retrieved as necessary for cooling. Using cheaper off-peak electricity to freeze PCM with the IHEX may allow for a decrease in electrical cooling costs. The reduction in utility costs combined with the low capital costs make IHEX systems commercially viable.

In one or more embodiments disclosed herein, the system may include four main components: IHEX, water and ice management in the IHEX tank, ice storage and utilization, and a control system. A chiller may use electricity to cool a heat transfer fluid to below the freezing temperature of water. This heat transfer fluid is sent into the IHEX to freeze water, also referred to as the PCM. Unless specified otherwise, water will refer to liquid water and ice will refer to solid water. This may produce ice and water which may be sent into the external storage tank and the cold can be discharged to provide cooling as needed. The controller may be responsible for adjusting the operating conditions of the invention in response to user demands and environmental conditions.

The IHEX tank may be an insulated tank that contains an IHEX, a water layer, multiple water distribution systems, an immiscible fluid layer, and a water transfer system. In some embodiments the immiscible fluid may be less dense than solid and liquid water and sits on top of the water layer. The IHEX may be submerged within the immiscible fluid layer and may distribute the cooling fluid from the chiller through a series of icephobic plates. A water flow distribution system may exist in the immiscible fluid to introduce water droplets in a controlled manner onto the IHEX plates. Droplet size and number may be controlled with design choices and operating conditions.

The external storage tank may be an insulated tank with water, ice, immiscible secondary fluid, air, or a combination thereof, and a flow distribution system, and/or a heat exchanger to integrate with an existing system. As the slurry enters into the tank, the ice floats to the top of the tank while the water remains at the bottom. There may be a skimmer in the tank to return any transferred secondary immiscible fluid to the IHEX tank. The ice remains in the tank until it is needed, where an external heat exchanger is used to remove heat from an outside system and increase the temperature of ice/water.

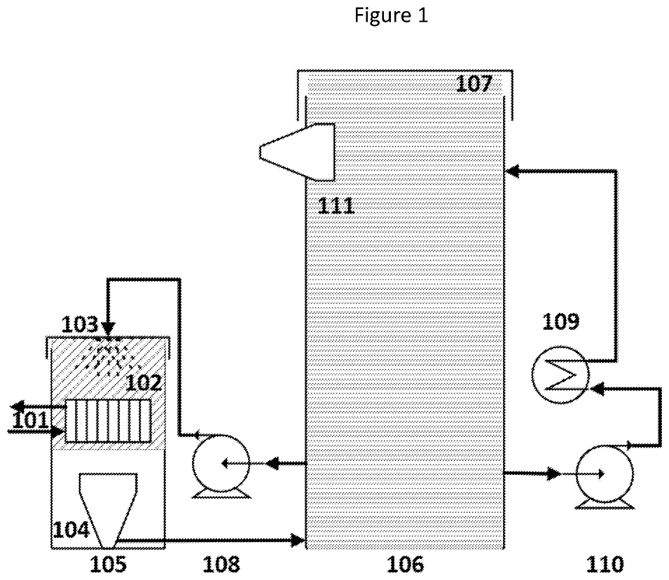

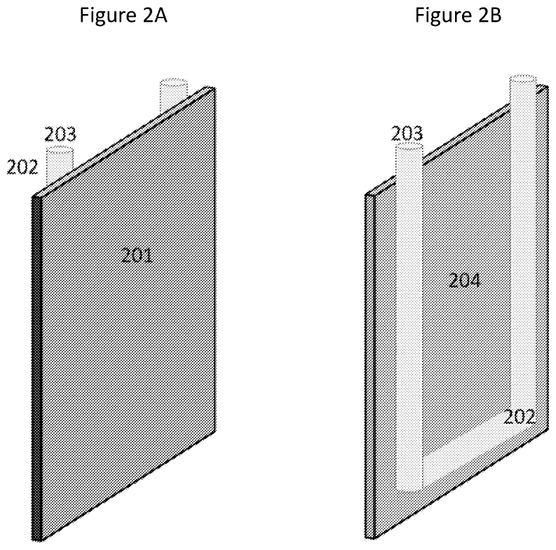

Referring now to FIG. 1, an embodiment of the thermal energy storage system is illustrated. The IHEX tank 105 may be thermally insulated to minimize heat losses. The tank may also be pressurizable to enable connection to taller storage tanks. The IHEX 101 resides within the secondary immiscible liquid 102. Heat transfer fluid may be pumped into the IHEX from a device such as, but not limited to, a chiller, a condensing unit, or a heat pump (not illustrated). This fluid may then circulate through the IHEX 101 and then flow back into the device that delivered it. The mechanism by which this working fluid may cool the plates is represented in FIG. 2, and discussed later in more depth

The droplet distribution system 103 may provide the means by which liquid water droplets are generated and delivered into the immiscible liquid 102. This distributor may consist of any number of pipettes, grommets, nozzles, or other openings which enable a consistent flow of water droplets. The design of the droplet distributor may be an array of openings with diameters between ⅛″- 1/64″ spaced between ¼″-1″ apart. In some embodiments, the array of openings may be from 1/64 inch or 1/32 inch to 1/16 inch or ⅛ inch in diameter, with any lower limit being pair with any upper limit. The droplet distributor design may be such to prevent ice accumulation within or on the distributor. A droplet is defined as some small packet of water present in the immiscible layer. Droplet size and number may be controlled with flow distributor shape and design, water flow rates, surface energies between water and the secondary immiscible fluid, and secondary immiscible fluid viscosity. Droplet size may be controlled to be between 1 and 500 μL, such as from 1, 5, 10, 20, or 25 μL to 100, 150, 200, 250, 300, 400, or 500 μL, where any lower limit may be paired with any upper limit. After the droplets fall through a portion of the immiscible fluid, they may thermally contact the heat exchanger plates with the PCM droplet being within a millimeter from the heat exchanger surface.

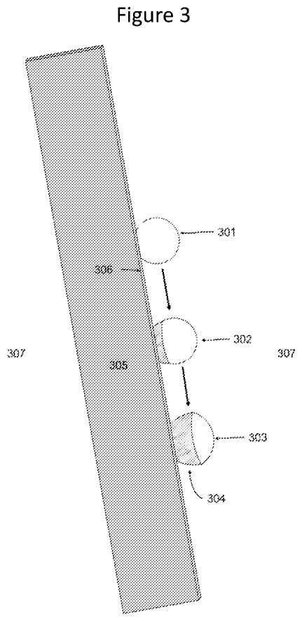

The droplet distribution system 103 may be designed to ensure proper size of the droplets. Droplets which are too small may become suspended in the immiscible fluid and not enter thermal contact with the heat exchanger plates, significantly decreasing heat transfer. In addition, the small droplets may follow the convective patterns of the immiscible fluid, and travel into regions, or into contact with portions of the ice generating tank that are not icephobic, where they may freeze and build up. Meanwhile too large droplets may have a too little thermal contact surface area for their volume and may travel too quickly through the immiscible layer or over the icephobic surfaces. As well, large drops may physically block the flow of other droplets by bridging between parallel IHEX plates and freezing, creating a block in the heat exchanger. The mechanics of droplet-IHEX interactions are shown in FIG. 3, discussed below.

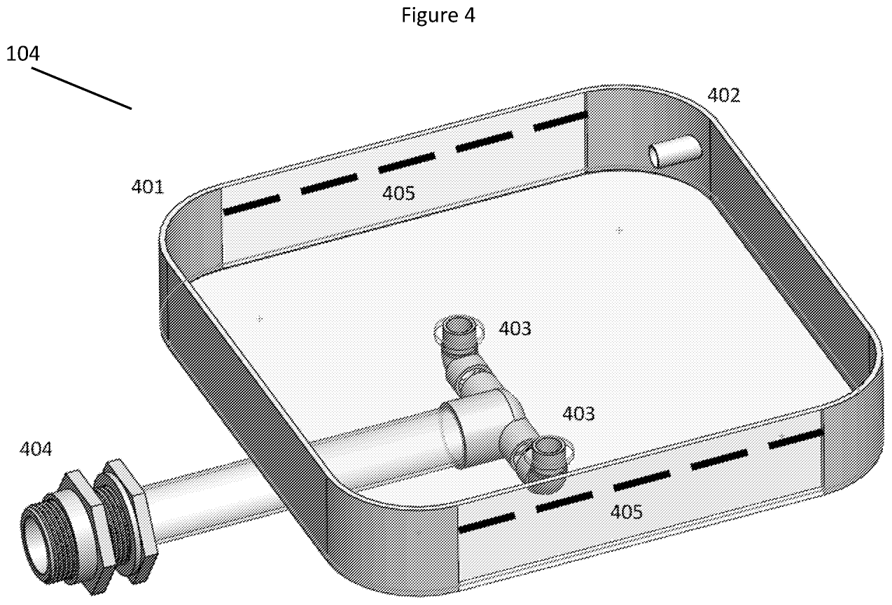

After the droplets have supercooled, partially frozen, or fully frozen on the IHEX plates, the droplets may descend to the bottom of the immiscible layer 102. Before entering the water layer, the droplets may accumulate at the interface between the immiscible layer and water for a variable amount of time, preventing the ice from agglomerating and minimizing the transfer of immiscible liquid. The size of the droplet layer may depend upon water flow rates, droplet size, surface energies between water and the secondary immiscible fluid, ice presence within the water layer, and flow regimes in the tank. Physical devices may be present near the interface as well to breakup or otherwise manipulate the droplets. The height of the interface may be controlled, by increasing or decreasing the amount of liquid water or immiscible fluid in the storage tank, to allow for fine tuning of the PCM-immiscible liquid interface kinetics. The ice in the droplets may be suspended within the water in the lower portion of the IHEX tank 105, forming an ice slurry. This slurry may be controlled with an ice transfer system 104. FIG. 4 shows a possible configuration of the ice transfer system. The ice transfer system may allow for the continuous removal of ice from the IHEX tank 105 into an external storage tank 106. The transfer of ice may be powered by a pump 108, which may also provide water to both the droplet distribution system 103 and the transfer system. The pump may be a common liquid pump, a slurry pump, or other pump. One of ordinary skill in the art will recognize that, with respect to the PCM-immiscible liquid interface, there may be some PCM in the immiscible liquid layer, and there may be some immiscible liquid in the PCM layer.

The pump's feed water may come from the external storage tank 106. This tank may be thermally insulated to minimize heat loss to the environment. There may be water, ice, immiscible secondary fluid, and air within the tank, or any mixture thereof. The external storage tank 106 may be any size relative the IHEX tank 105, such as larger or small. The external storage tank 106 may be taller or shorter than the IHEX tank 105, may be wider or narrower than the IHEX tank 105, and may be located physically above, below, or on the same elevation as the IHEX tank 105. Accordingly, the size and placement of the storage tank 106 relative to the IHEX tank 105 may be selected to take advantage of any natural surface features or bulk climate at the installation site.

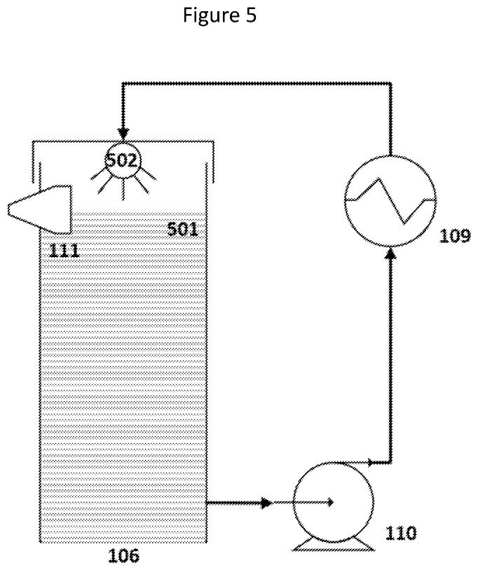

Ice slurry may enter from the transfer system at the bottom of the external storage tank 106, where the ice will tend to float toward the top of the storage tank while the liquid water remains at the bottom. The ice at the top of the tank may compact itself, due to buoyancy forces, increasing the energy storage density of the system. A second pump 110 may be used to supply an external heat exchanger 109 with water or ice slurry. A representation of such a heat exchanger method is shown in FIG. 5, discussed below.

An immiscible fluid return 111 may be used to return transferred immiscible fluid to the IHEX tank. The components of the immiscible fluid return 111 may include but are not limited to a pump, a skimmer which rests at the water-immiscible interface, and a method of avoiding ice transfer. The immiscible fluid in the return 111 may be at the top of the storage tank 106 and originates from the IHEX tank 105. As PCM gets transferred from the IHEX tank 105 into the storage 106, some immiscible fluid may travel with the PCM. Due to the density differences between liquid/solid PCM and the immiscible fluid used, the latter may accumulate at the top of the tank. The immiscible fluid may then be sent back to the IHEX tank 105.

The external storage tank 106, in one or more embodiments, may also be equipped with a floating roof 107. Such a roof may enable the external storage tank 106 to be completely filled without over pressurizing the tank. Such a floating roof 107 may also allow the passive purge of water/ice/PCM from the external storage tank 106 in the event that too much fluid is pumped in the tank. As the PCM is water/ice, there may be no environmental concerns or ramifications to such an unplanned release of material to the local environment. In other embodiments, the roof may be a typical closed tank roof. FIG. 2A and FIG. 2B illustrate the respective front and back of an IHEX plate according to one or more embodiments disclosed herein. The IHEX plate construction may include, but is not limited to, pillow plate, plate coil, or brazed tube-to-plate. The front plate surface 201 may be composed of a thermally conductive material to assist in heat transfer between the water and the heat transfer fluid in tubing 202. The front plate surface 201 may be coated in a smooth icephobic coating. Such an icephobic coating may include, but is not limited to, polyisobutylene (PIB, butyl rubber), paraffin, poly t-butyl methacrylate (PtBMA), polydimethylsiloxane (PDMS), polypropylene (PP), polyethylene (PE), polybutadiene, nylon 10,10, polytrifluoroethylene, poly n-butyl methacrylate (PnBMA), polyvinylidene fluoride (PVDF), or polystyrene (PS), or a fluoropolymer coating including but not limited to poly(hexafluoropropylene), polytetrafluoroethylene (PTFE), Ethylene tetrafluoroethylene (ETFE), fluorinated ethylene propylene (FEP), perfluroalkoxy alkane (PFA), polychlorotrifluoroethylene (PCTFE), polytrifluoroethylene, or combinations thereof.

The front plate surface 201 may also be modified in such a way as to increase the adhesion of the icephobic layer, promote ice nucleation, and/or increase heat transfer. The tubing 202 may be welded, pressed, brazed, or adhered onto the plate back 204. There may be modifications to the plate or tubing surfaces to increase contact and heat transfer. The shape and length of tubing on the plate back 204 may vary with desired heat transfer profiles. The tubing interior 203 may be filled with the cold chiller, condensing unit, or heat pump working fluid. The tubing size and the working fluid flowrate may depend upon the desired heat transfer and flow characteristics. The plate back 204 may be modified to increase the adhesion, heat transfer, or surface area of tubing 202 which is in contact with the plate. The plate back 204 may also have a similar icephobic modification as surface 201. Coating the back of the plate may prevent ice from accumulating on the under side of the IHEX plates as the ice travels through the IHEX tank. Referring now to FIG. 3, the freezing process, according to one or more embodiments disclosed herein, is illustrated. A liquid water droplet 301 is shown where the droplet may be entirely liquid after just beginning to thermally interact with the cooled surface 305 of one of the IHEX plates. The droplet 301 may exhibit a high contact angle due to both the hydrophobic coating 306, and the surrounding immiscible fluid 307. The observed contact angle may be greater than the contact angle observed with the droplet on the same surface exposed to air. In some cases, when water exhibits a contact angle greater than 85° for a rough surface (or 95° for a smooth surface) in air, the surface may exhibit non-adhesion of ice when air is replaced by the immiscible fluid. As the droplet continues to move down the plate (due to gravitational and buoyant forces), the temperature of the droplet may decrease until it reaches its nucleation, or freezing, temperature where solid ice begins to form. Upon nucleation, a small quantity of frozen ice may form at or close to the interface between the droplet and the hydrophobic coating. This solid may take the form of a thin layer at the bottom of the droplet, dendrites extending into the droplet, or any other form of frozen material being formed in the droplet. This stage of the freezing process is illustrated as 302, with a partially frozen droplet.

The final stage of the freezing process is illustrated as 303, where the frozen portion of the droplet has grown as the droplet continues to travel down the plate. The droplet may be able to keep moving after nucleation due to the gravitational and buoyancy forces being greater than the adhesion force of ice. The adhesion force may be further reduced in part due to the hydrophobic coating. The hydrophobic coating used may be very smooth, which may make the ice interface smooth as well. Having two smooth surfaces may reduce the overall amount of friction experienced by the droplet, thus allowing the freezing droplet to continue traveling despite having, at least partially, changed phase. The angle of the plate from horizontal may be set from 25° to 85°. Such angle may be from 25°, 35°, 45°, or 55° to 65°, 75°, or 85° with any lower limit pair with any higher limit. At too high of an angle, droplets may travel too quickly over the plate surface and have insufficient thermal contact. At too low of an angle, droplets may have insufficient momentum to overcome minor defects in the icephobic material and adhere to the plate.

Referring now to FIG. 4, an ice transfer system 104 according to one or more embodiments disclosed herein is illustrated. The base of the system, or flow diverter, 401 may be below the water-immiscible fluid interface 405, and the open top may extend above the interface 405. The partially circular shape may be combined with a tangential flow nozzle 402 to create a whirlpool like flow at, or near, the bottom of the IHEX tank 105. This flow pattern may keep the water and ice at the tank bottom together in slurry form. The whirlpool like flow may also prevent the ice from forming larger blocks at or near the water-immiscible fluid interface 405 and potentially blocking the outlet flow. The flow diverter 401 may be made of, or coated with, icephobic materials to prevent ice agglomeration on the interior or exterior surfaces. The flow diverter shape may be changed to alter flow characteristics of the ice slurry, such as being made completely circular or more square in nature. As well, there may be icephobic baffles or diverters within the interior volume of the flow diverter 401 (not illustrated) to modify the flow pattern. There may be one or more nozzles 402 to further alter flow characteristics as well.

The transfer system outlet 403 may continuously remove the slurry ice from the bottom of the IHEX tank 105. There may be one or multiple outlets, and they may be at the bottom or sides of the flow diverter 401. The transfer system 104 may be sized large enough to ensure the passage of small agglomerations of ice, while small enough to maintain high enough flowrates to avoid ice agglomeration. The transfer system 104 piping may leave the IHEX tank 105 through a valve or connection point 404 through the bulkhead wall. The water-immiscible fluid interface 405 may be raised or lowered to adjust slurry production kinetics, immiscible fluid transfer, or droplet interface layer position.

Referring to FIG. 5, an ice melting method according to one or more embodiments is illustrated. The stored ice 501 in external storage tank 106 may be in either slurry or solid form. There may also be air, immiscible fluid, and liquid water, or combinations thereof, in the external storage tank 106. A pump 110 may send water or ice slurry to cool a second, external heat exchanger 109. The warmed returning fluid may re-enter the external storage tank 106 through flow distributor 502, which may be one or more showerheads, nozzles, misters, or other working fluid dispersion mechanisms. This flow may attempt to maximize ice melting while minimizing the possibility of thermal shortcuts.

A variety of sensors and controllers may be used to ensure optimum operation of the thermal energy storage system represented in FIG. 1. The sensors may include, but are not limited to, those as follows (not illustrated in the Figures). IHEX 101 may have temperature and coolant flowrate sensors to measure the system cooling rates. The tanks 105 and 106 may have thermometers to measure different fluid layer temperatures. As well, flowmeters may be located at droplet distributor 103 and ice transfer system 104 to measure ice production and storage rates. External storage tank 106 may have ultrasonic level sensors to determine the amount of ice stored. The external heat exchanger 109 may have temperature and flow meters to determine the utilized cooling load. Various sensors may monitor operating conditions to ensure safe operation of the system. Other various sensors may measure environmental conditions such as current electrical demand and cost, temperature, and humidity. Controllers situated throughout the system may allow for adjustment of the operating conditions in response to changing inputs. Controllers may include, but are not limited to, variable frequency drives, valves, or other flow controllers to adjust the flowrates in the system. As well, there may be connections between the IHEX tank and the external heat exchanger, bypassing the external storage tank 106 allowing for a controlled response to system conditions to maximize efficiency and lower storage usage. Such bypass may lead to operating the IHEX 101 in such a way where the IHEX only cools liquid PCM, without leading to any phase change transition, while additional cooling may or may not be provided from the cold, or solid, PCM stored in external storage tank(s). Such bypass may also be used during events where the storage capacity of the storage tank 106 has been exceeded and the IHEX and external heat exchanger are running “on-demand” In other words, the system may be operated in such a way that the charging occurring in the IHEX and the discharging occurring in the external heat exchanger happen at, or near, the same rate.

While operating in such an operating mode, the storage tank 106 may or may not provide additional, complementary cooling. In one or more embodiments, the IHEX tank 105 may provide an ice slurry to external cooling, heat exchangers, or other external devices, which may have the advantage of being a high cooling density medium and may have benefits in high density cooling applications such as in high-power computing, for example. In other embodiments, the IHEX tank 105 may provide a cooled liquid PCM to external cooling, heat exchangers, or other external devices. This may have the advantage of being much more efficient for air conditioning low cooling density applications such as air conditioning, for example.

A controlling computer may be present to control the system autonomously and safely. The computer may operate the system to minimize electrical costs. This may be achieved by leveling customer load or minimizing peak demand The computer may also operate to ensure maximized system discharge rate for a set period of time, irrespective of peak demand hours and electricity costs. As well, the computer may operate to maintain a certain reserve of ice storage to provide resiliency for emergency operations. Algorithms within the controlling computer may allow the system to respond to environmental changes and/or consumer demands.

Unless defined otherwise, all technical and scientific terms used have the same meaning as commonly understood by one of ordinary skill in the art to which these systems, apparatuses, methods, processes, and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A heat exchange system comprising:
an icephobic heat exchanger (IHEX) tank;
a phase change material (PCM) held in the IHEX tank;
an immiscible liquid layer held in the IHEX tank, wherein the immiscible liquid layer has a density lower than a density of both the solid and liquid PCM, the PCM and the immiscible liquid layer meeting at a PCM-immiscible liquid interface;
a heat exchanger located within the immiscible liquid layer; and a distributor located above the heat exchanger configured to introduce a plurality of liquid PCM droplets into the immiscible liquid layer;
a transfer mechanism configured to remove PCM from the IHEX tank; and
an external storage tank configured to receive the removed PCM.

2. The system of claim 1, wherein the heat exchanger is coated with an icephobic polymer coating.

3. The system of claim 2, wherein the icephobic polymer coating is selected from the group consisting of poly(hexafluoropropylene), polytetrafluoroethylene (PTFE), fluorinated ethylene propylene (FEP), polychlorotrifluoroethylene (PCTFE), polytrifluoroethylene, ethylene tetrafluoroethylene (ETFE) or combinations thereof.

4. The system of claim 1, wherein the PCM is water.

5. The system of claim 4 where the PCM includes one or more of an ice nucleating agent or freezing point modifier.

6. The system of claim 1, wherein the distributor creates PCM droplets having a volume in the range from 1 μL to 500 μL in the immiscible liquid.

7. The system of claim 6, wherein the distributor comprises an array of openings each opening having a diameter of 1/64 inch to ⅛ inch, spaced apart by ¼ inch to 1 inch.

8. The system of claim 1, wherein the heat exchanger is a plate-based heat exchanger.

9. The system of claim 8, wherein the heat exchanger comprises one or more plates having a plate angle of from 25° to 85° relative to a horizontal plain.

10. The system of claim 1, wherein the transfer mechanism comprises:
one or more flow inlets to supply a liquid to agitate a mixture of solid and liquid PCM;
an outlet pipe for removing PCM from the IHEX tank; and
a layer of PCM droplets at the PCM-immiscible liquid interface level.

11. The system of claim 10, wherein the transfer mechanism is configured to agitate the PCM in a circular pattern.

12. An energy storage system comprising the heat exchange system of claim 1, the energy storage system further comprising:
a heat exchanger inlet and a heat exchanger outlet, wherein the heat exchanger inlet and heat exchanger outlet provide thermal communication between the heat exchange system and one or more process units during charging and discharging.

13. The energy storage system of claim 12, further comprising one or more storage vessels located externally to the heat exchange tank.

14. The energy storage system of claim 13, further comprising one or more pumps for transferring PCM, immiscible fluid, or both, between the heat exchange tank and the one or more storage vessels, or an external device.

15. The energy storage system of claim 14, further comprising an oil recapture mechanism, the oil recapture mechanism comprising:
one or more skimmers at the PCM-immiscible liquid interface in the storage vessels;
one or more fluid connections between the one or more skimmers, one or more pumps, and one or more storage vessels.

16. A heat exchange method for exchanging heat between a heat transfer fluid and a phase change material (PCM), the method comprising:
holding an immiscible liquid layer in a tank;
feeding a plurality of liquid PCM droplets into the tank proximate a top of the tank;
contacting the plurality of liquid PCM droplets on a heat exchanger and cooling the liquid PCM droplets, producing a supercooled liquid, partially frozen liquid, or a solid PCM;
transferring the solid PCM from the tank.

17. The method of claim 16, further comprising prohibiting accumulation of the solid PCM on a surface of the heat exchanger via an icephobic polymer coating and the immiscible liquid on the surface of the heat exchanger.

18. The method of claim 16, further comprising transferring the partially frozen PCM via maintaining a layer of droplets at an interface between the PCM and the immiscible liquid, agitating the PCM layer with a liquid PCM inlet stream, and removing the liquid PCM from the tank.

19. An energy storage method using the system of claim 1, the method comprising:
charging the system by freezing the liquid PCM; and
discharging the system by melting the frozen PCM,
the energy storage method further comprising prohibiting an accumulation of the frozen PCM on the heat exchanger during charging.

20. The method of claim 19, wherein charging comprises:
pumping liquid PCM from one or more secondary storage tanks or external PCM heat exchanger to the heat exchange tank;
contacting the liquid PCM with the heat exchanger;
cooling, supercooling, partially freezing or fully freezing the liquid PCM in contact with the heat exchanger using a cold heat transfer fluid, producing a frozen, partially frozen, or liquid PCM;
collecting frozen or partially frozen PCM below the heat exchanger at an interface between the liquid PCM and the immiscible liquid layer;
maintaining the frozen or partially frozen PCM in a fluid suspension; and
transferring the liquid PCM to the one or more secondary storage tanks.

21. The method of claim 19, wherein discharging comprises:
pumping a cold PCM from the storage tank through an external heat exchanger;
partially melting, increasing the temperature of the cold PCM, or both; and
decreasing a fluid temperature of a fluid to be chilled.

22. The method of claim 19, wherein discharging uses:
an external PCM heat exchanger, whose operation comprises:
pumping cold PCM from the IHEX tank through an external heat exchanger
partially melting, increasing the temperature of the cold PCM, or both; and
lowering the fluid temperature on the other side of the heat exchanger

23. The method of claim 19, wherein discharging comprises and
pumping a cold PCM from the storage tank directly to a piping infrastructure associated with a thermal load that is desired to be cooled;
partially melting, increasing the temperature of the cold PCM, or both; and
cooling the thermal load.
